(19) United States
(12) Patent Application Publication
(10) Pub. No.: US 2007/0285561 A1
(43) Pub. Date: Dec. 13, 2007

(54) Integrated camera/photo display unit

(75) Inventor: Ieon Chen, Fountain Valley, CA (US)

Correspondence Address: STETINA BRUNDA GARRED & BRUCKER, 75 ENTERPRISE, SUITE 250, ALISO VIEJO, CA, 92656, US

(73) Assignee: Innova Electronics, Inc.

(21) Appl. No.: 11/441,534

(22) Filed: May 26, 2006

(51) Int. Cl. H04N 5/225

(52) U.S. Cl. 348/373; 348/207.99

(57) ABSTRACT

A full-framed-display camera is provided which includes a display screen that is disposed on a rear section of the camera and extends about substantially all of the rear section of the camera. An integrated camera/photo display unit is also provided for displaying a digital image. The integrated camera/photo display unit includes the camera and a frame. The frame includes a casing, a base, and a cradle that is sized and configured to receive at least a portion of the camera therein. The cradle may include a communications connector and an electrical connector that are operative to engage the respective ones of a communications port and an electrical port of the camera when the camera is disposed in the cradle.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to digital image display devices, and more specifically to an integrated camera/photo display unit that is uniquely configured to facilitate the display of the digital pictures with a unique apparatus configuration which allows the camera to be mountably displayed within the photo frame.

Until recently, conventional photography was only performed using film. After exhausting a roll of film, a user was required to develop the film in order to see the pictures that were taken. This process often produced several acceptable pictures, as well as several pictures that were undesirable. As a result, unnecessary time and expense would be made to develop pictures that were found to be unwanted. The advent of digital camera technology and its proliferation in the marketplace has alleviated these problems in large measure.

In fact, the widespread use of digital cameras not only allows users to preview their pictures prior to printing them, but also has enabled users to share their pictures with others over the internet and to review those pictures by using their computer monitors. Typically, after taking a picture with a digital camera, the user must download the picture from the camera by connecting the camera to a computer via a connectivity cable or the user may remove the camera's memory card and insert it into a card reader that is connected to the computer. Some digital cameras also include display screens which allow the user to review the pictures that have been taken or will have been taken. In either case, the user usually downloads the digital images from the memory card or camera and stores them onto a computer or directly prints the pictures onto paper. The digital images may then be reviewed, shared with others by displaying or sending the digital images over the internet, saving them to other storage media, or by printing out the digital image.

An alternative to printing digital images taken on a digital camera is displaying such images on a computer, perhaps by using a screen saver or slide show program. In such programs, the user may program their computer to display digital images as desired. These programs may provide the user with a desirable reviewing alternative to simply printing the digital images. Nevertheless, these alternatives require the use of a computer and an often bulky computer monitor in order to showcase the digital images. Furthermore, inexperienced users may find it difficult to download the digital images, program the computer, and review the digital images in such a way, especially considering the many steps required in the process. As a result, the display of digital images on computer screens may not be appealing to some users, other users may be unable to benefit from such programs, and yet other users may find that the process is too time consuming to reconfigure and update their computers each time they acquire new digital images. Thus, although home computers may be used to display digital images, it may not be a universally appealing or feasible solution.

Therefore, there exists a need in the art for a simplified method and apparatus that allows for the display of digital images that may not only provide an appealing display, but that is also technically feasible for all possible users. There is a need in the art for a device that allows a user to easily capture and display digital images without requiring interaction with a computer monitor or with complex computer programs. Furthermore, there is a need in the art for an attractive and user-friendly apparatus that may be displayed prominently in the home that can be used on a daily basis.

### BRIEF SUMMARY

In order to address some of the above noted deficiencies in the prior art, there is provided an integrated camera/photo display unit for displaying a digital image, which may be digitally formatted as digital image data. The integrated camera/photo display unit comprises a digital camera and a frame. As will be described in further detail below, the digital camera may be used in combination with the frame to provide a simple and effective assembly and method to showcase digital images taken by the camera. In fact, due to the unique configuration of the frame, the camera may be received therein and the digital images may be displayed as though the integrated camera/photo display unit were a single standard picture frame. As described below, the frame may facilitate the transfer of information and electrical power to the camera, and the camera provides a visual display area that may be showcased with the frame. Therefore, the integrated camera/photo display unit tends to produce a desired final presentation of the digital image while providing full technical functionality to facilitate use of the camera.

In order to facilitate use of the camera, the camera may use a storage medium which stores the image data. The storage medium may be one of those commonly found in the art, such as compact flash, memory stick, secured digital (“SD”), extreme digital picture card, multimedia card, and/or mini SD. Furthermore, it is contemplated that other formats of memory cards and other storage media may be accommodated for use with the display device in embodiments of the present invention.

According to an aspect of the present invention, the digital camera defines front and rear sections and top and bottom ends. The camera may include an image capture unit, an orientation sensor, a memory unit, a display screen, an electrical port, and a communications port. The image capture unit of the camera is housed by the camera and is operative to capture an image and to convert the image to image data. The image data is representative of the image. The orientation sensor is operative to determine an orientation angle of the camera upon capture of the image. In this regard, the orientation sensor produces an orientation signal that is representative of the orientation angle and is included within the image data. Thus, each digital image may specifically include reference to assist in the proper orientation of the image when the image is transferred and/or displayed.

The memory unit of the camera is in electrical communication with the image capture unit to receive the image data and to store the image data. Additionally, the display screen defines a viewing area and a screen periphery. The display screen is disposed on the rear section of the camera. The display screen is operative to receive the image data and to convert the image data for displaying the image on the display screen. The electrical port of the camera may be operative to receive electrical power for powering the digital camera. Finally, the communications port is operative to send and receive image data.

According to another aspect of the present invention, the frame may be utilized to receive the camera to display the image shown on the display screen of the camera. The frame is preferably electrically connectable to a power source and to a computer. The frame includes a cradle, a casing, and a base. The cradle is sized and configured with at least the bottom end of the camera being removably receivable to within an interior of the cradle. The casing is attachable to the cradle and defines a viewing aperture and a rear surface. The viewing aperture is sized and configured with the viewing area of the display screen of the camera being visible therethrough.

In an implementation of the present invention, the cradle may include an electrical connector and a communications connector. In this regard, each of the electrical connector and the communications connector may be disposed within the interior of the cradle to engage the respective ones of the electrical port and the communications port when the camera is received within the interior of the cradle. The electrical connector may be operative to supply power to the electrical port for use by the camera. Further, the communications connector may be attached to at least one of the cradle, the casing, and/or the base and be operative to perform at least one of transferring the image data from the camera to the computer and transferring the image data from the computer to the camera.

In another implementation of the present invention, the viewing aperture of the casing may be sized and configured to substantially mate with the viewing area of the display screen of the camera. Further, the rear surface of the casing mates with the rear section of the camera upon the camera being received within the interior of the cradle. Additionally, the base is attachable to at least one of the cradle and the casing. In this regard, the base is sized and configured to support the frame upon a display surface.

In an implementation of the present invention, the viewing aperture preferably substantially mate with the viewing area of the display screen. For example, the viewing aperture of the casing may be configured to accommodate a display screen having a 3.5″ diagonal viewing area. Alternatively, the viewing aperture of the casing may be configured to accommodate a display screen having a 5″ diagonal viewing area. Nevertheless, the viewing aperture may be sized and configured to correspond to the viewing area of the display screen of any dimension.

In an implementation of the present invention, the base may be integrally formed with the casing and the cradle. Further, the casing may be removably attachable to the frame. Such a configuration may allow for versatility in matching a specific decor or design plan when using the integrated camera/photo display unit.

In order to facilitate use of the camera and integrated camera/photo display unit, the display screen of the camera may preferably be a touch screen. Additionally, the display screen of the camera may also provide at least 3.5″ diagonal viewing area. However, in preferred embodiments, the display screen should provide a 5″ diagonal display area. Nevertheless, it is contemplated that the display screen may exceed 5″ in order to provide a larger viewing area for the integrated camera/photo display unit.

According to one implementation of the integrated camera/photo display unit, the camera may include an orientation sensor, such as a mercury switch.

In a further implementation of the present invention, the memory unit of the camera may include at least one data slot which may be sized and configured to receive storage mediums therein and to retrieve and store image data onto and from the storage medium.

According to yet another implementation of the present invention, the display screen of the camera defines a full-framed viewing area for displaying the image. The viewing area thereof occupies substantially all of the rear section of the camera for providing maximum size of the display screen. Further, the camera may also include at least one frame engaging member disposed on the camera for securely engaging the camera to the frame.

In an additional embodiment of the present invention, the cradle of the frame includes at least one camera engaging member. The camera engaging member is preferably sized and configured to mate with the frame engaging member of the camera for stabilizing the camera when the camera is received within the cradle.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a top perspective view of a digital camera according to an embodiment of the present invention;

FIG. 2 is a bottom perspective view of the digital camera including a display screen, according to an embodiment of the present invention;

FIG. 3 is a front view of an integrated camera/photo display unit including the digital camera and a frame, according to an embodiment of the present invention;

FIG. 4 is a top cross sectional view of the frame illustrating electrical and communications components, according to an embodiment of the present invention;

FIG. 5 is a front view of the integrated camera/photo display unit wherein the digital camera is received into a cradle of the frame for displaying digital images on the display screen of the camera according to an embodiment of the present invention;

FIG. 6 is a side view of the integrated camera/photo display unit illustrated in FIG. 5; and

FIG. 7 is a flow chart illustrating the interrelationship of the digital camera to the frame, according to another embodiment of the present invention.

### DETAILED DESCRIPTION

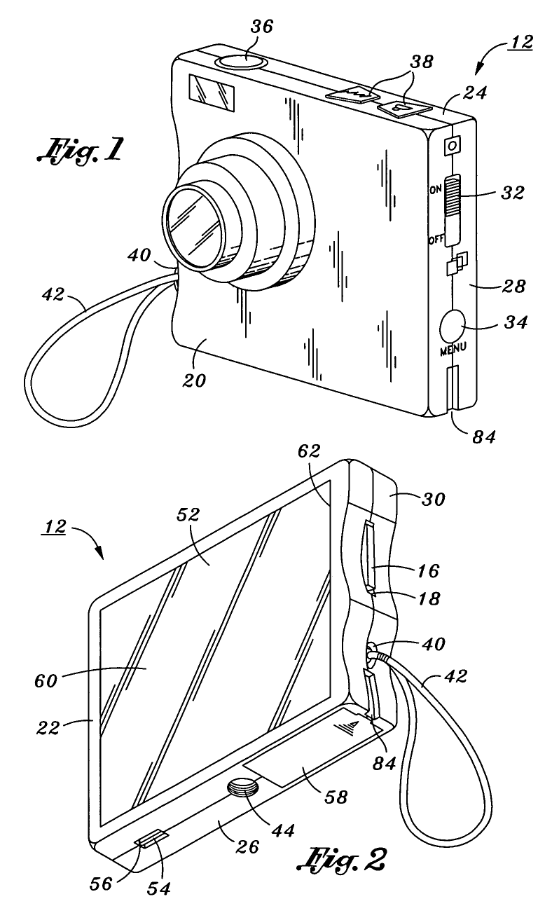

Referring now to the drawings wherein the showings are for purposes of illustrating preferred embodiments of the invention only, and not for purposes of limiting the same, FIGS. 1-6 illustrate various aspects of an integrated camera/photo display unit 10, including a digital camera 12 and a frame 14, which integrated camera/photo display unit 10 is utilizable to display a digital image. The frame 14 is a camera-receiving frame. The integrated camera/photo display unit 10 advantageously provides a user not only with improved ease of use, but also provides the user with a simple and effective method of displaying digital images taken by the user using the camera 12. The integrated camera/photo display unit 10 tends to mimic the appearance and simplicity of a standard desktop photo and frame combination while providing great flexibility and interchangeability for a user, such as the novice, as well as the advanced photographer.

As will be described in further detail below, the digital camera 12 may be used in combination with the frame 14 to provide a simple and effective assembly and method to showcase digital images taken by the camera 12. In fact, due to the unique configuration of the frame 14, the camera 12 may be received therein and the digital images may be displayed as though the integrated camera/photo display unit were a single standard picture frame. As described below, the frame 14 may facilitate the transfer of information and electrical power to the camera 12, and the camera 12 provides a visual display area that may be showcased with the frame 14. Therefore, the integrated camera/photo display unit tends to produce a desired final presentation of the digital image while providing full technical functionality to facilitate use of the camera 12.

As may sometimes be the case in modern society, the progress of technology often exceeds the pace of progress for various individuals in society. Thus, despite technological advancements, some individuals are unable to avail themselves of such technology due to lack of familiarity with such technology. One of the best examples proves to be that of digital cameras. There are many users who would likely utilize such technology were it more accessible and immediately useful to the user. In this regard, embodiments of the present invention seek to remedy these deficiencies by providing improved ease of use for such technologically-challenged users, as well as improved enjoyment of the camera. These advantages, and others, will be explained in further detail below.

As mentioned above, the digital image taken by the user using the camera 12, regardless of the subject of the digital image, may be digitally formatted as digital image data. In this regard, it is contemplated that the digital camera 12 may use a storage medium 16, which is operative to store the image data and from which digital data may be retrieved. The storage medium 16 may be one of those commonly found in the art, such as compact flash, memory stick, secured digital (“SD”), extreme digital picture card, multimedia card, and/or mini SD. According to an implementation of the present invention, the camera 12 preferably includes at least one data slot 18 which may be sized and configured to receive the storage medium 16 therein and to retrieve and store image data onto and from the storage medium 16. The data slot 18 may be a 6-in-1 card reader data slot 18 that is integrated into the camera 12. The data slot 18 may therefore provide the user with the flexibility of choosing and using nearly any type of storage medium 16. Thus, as other formats of memory cards and other storage media develop, they may be accommodated for use with the data slot 18 of the camera 12.

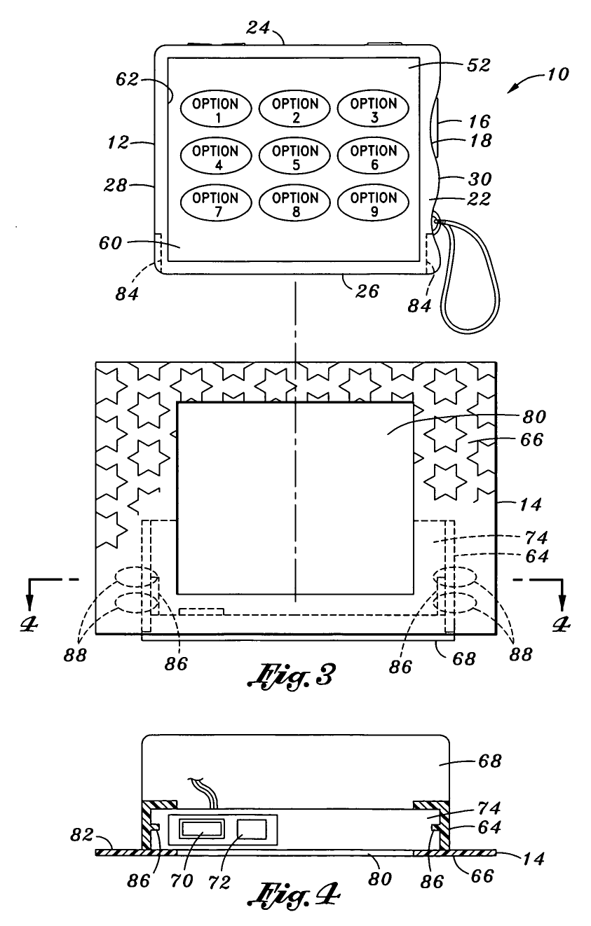

As illustrated in FIGS. 1 and 2, the digital camera 12 defines front and rear sections 20, 22, top and bottom ends 24, 26, and left and right sides 28, 30. As shown therein, the camera 12 may include various user controls, such as the on/off switch 32, a menu button 34, a shot button 36, and zoom controls 38. Further, the camera 12 may include other features such as a hook 40, a hand strap 42, and a tripod attachment point 44. The camera 12 preferably includes an image capture unit 46, a memory unit 50, an orientation sensor 48, a display screen 52, an electrical port 54, and a communications port 56, as illustrated in FIGS. 2 and 7. The electrical port 54 and the communications port 56 may a single port, or as shown in FIG. 2, may be two separate ports. The electrical port 54 is operative to receive electrical power for powering the digital camera 12 and may be in electrical communication with a battery element 58, which may be a standard rechargeable battery operative to provide the user with the ability to use the camera 12 over extended periods of time. Thus, the electrical port 54 may simply be defined as an electrical contact through which power is fed to the power-requiring components of the camera 12. However, the electrical port 54 may also be in electrical communication with rechargeable batteries (which provide the necessary power to the power-requiring components of the camera) in order to recharge the batteries. The communications port 56 is operative to send and receive image data. The function and utility of the electrical port 54 and the communications port 56 will also be described in greater detail below.

It is contemplated that the features and controls mentioned herein may be variously configured and that the camera 12 design may be modified in numerous ways without departing from the scope of embodiments of the present invention. For example, the controls and features may be arranged to be on either of the left and right sides 28, 30, top and bottom ends 24, 26, or front and rear sections 20, 22 of the camera 12. In this regard, one of the objects of embodiments of the present invention is to provide ease of user control and to facilitate enjoyment and use of the integrated camera/photo display unit 10. Thus, the general configuration preferably incorporates useful controls and features that are easy to identify and use.

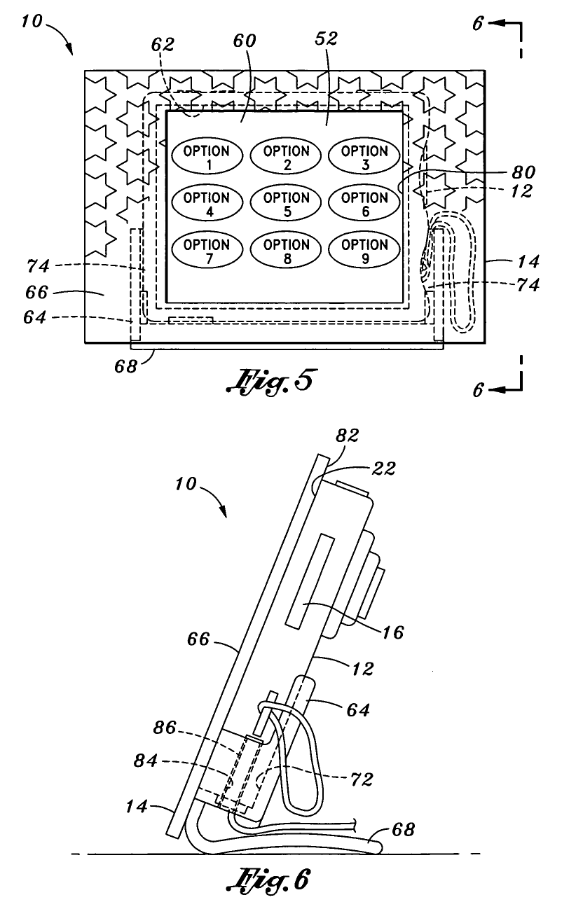

FIGS. 3 and 4 illustrate the frame 14, according to another aspect of the present invention. The frame 14 may be utilized to receive the camera 12 to display the image shown on the display screen 52 of the camera 12. Thus, after the digital image is taken by the user, the user may place the camera 12 into the frame 14, with the display screen 52 showing the digital image recently taken, or any desired digital image. In this regard, as mentioned above, the integrated camera/photo display unit 10 tends to provide the functionality of a standard photo and frame combination while providing the user with the ability to immediately display any desirable digital image without being required to process the digital image into an actual physical photo print. This advantageous aspect of the present invention allows users to enjoy the flexibility of digital photography without the additional cost of developing photo prints (and the necessary labor of transferring image data, burning cds, emailing or downloading image data to a photo printer, etc.). This flexibility and ease of use provide for many other advantages, including the use of aesthetically pleasing designs for the frame 14, and such advantages are unique and distinct. Therefore, the digital camera 12 may be utilized similarly to other digital cameras in use today; the digital images may taken, the camera 12 may be received within the frame 14, and the digital images may then be displayed on the display screen 52 of the camera 12 as though the entire integrated camera/photo display unit 10 were one simple photo and frame combination.

With specific reference to the digital camera 12, as shown in FIG. 7, the image capture unit 46 of the camera 12 is housed by the camera 12 and is operative to capture an image and to convert the image to image data. As mentioned above, the image data is representative of the image. The capture unit 46 of the camera 12 may include the typical functionality and options that are useful in digital photography. In this regard, the capture unit 46 may be in communication with the orientation sensor 48, the electrical port 54, a memory unit 50, and the display screen 52. Thus, as is known in the art, the image data and electrical power may be exchanged between the several components of the camera 12. In addition, the camera 12 further includes the display screen 52, which defines a viewing area 60 and a screen periphery 62. As shown in FIG. 2, the display screen 52 is preferably disposed on the rear section 22 of the camera 12. The display screen 52 is operative to receive the image data and to convert the image data for displaying the image on the display screen 52. As shown in FIG. 7, the display screen 52 is preferably in communication with the communications port 56, memory unit 50, electrical port 54, and the image capture unit 46 of the camera 12.

The memory unit 50 of the camera 12 is preferably in communication with the image capture unit 46 to receive the image data and to store the image data. Further, the memory unit 50 may be in communication with the electrical port 54 and the communications port 56 for receiving electrical power and for transferring (including the receipt and sending) of image data. As mentioned above, the memory unit 50 may include the data slot 18 which may use the storage medium 16. Thus, it is contemplated that the memory unit 50 may be operative, as is known in the art, to transfer image data to and from the storage medium 16 in the data slot 18.

According to another aspect of the present invention, the camera 12 may include the orientation sensor 48. The orientation sensor 48 of the camera 12 may be utilized to assist the user in properly displaying a digital image; in other words, the user need not worry about incorrect image orientation. For example, when taking a picture, the user may often rotate the camera 12 in order to capture an image in landscape or portrait orientation, depending on the preference of the user for that given image.

In operation, the orientation sensor 48 is operative to determine an orientation angle of the camera 12 upon capture of the image, and the orientation sensor 48 may produce an orientation signal that is representative of the orientation angle. The orientation sensor 48 may be a mercury switch such as a REED Relay/Mercury Wetted SPST. Further, the orientation sensor 48 may be a gyroscope compensation orientation sensor or a 3D orientation sensor. In some embodiments, the orientation signal may be representative of an upright orientation angle and be included within the image data, which may be saved together on the storage medium 16. The orientation signal may be read by the camera upon display of the image in order to orient the image uprightly on the display screen 52. Thus, when the digital image is subsequently retrieved for review or display, the orientation signal should provide the proper orientation angle in order to ensure that the digital image is presented appropriately. For example, if the camera 12 is rotated 30 degrees clockwise when the image is taken, the orientation signal should instruct the camera 12 to rotate the image 30 degrees counterclockwise in order to ensure that the digital image is upright. The orientation signal may also allow the image to be continuously displayed uprightly, such as if the camera is rotated while displaying the image. Further, the camera may be set down upside-down or on its side, and nevertheless display the image uprightly. Thus, the image may always be displayed in the orientation in which it was seen. This feature may also be selectively used in order to provide choice to the user.

Furthermore, in some situations where the rotation of the digital image would otherwise leave empty spaces on the display screen 52 when displayed, such as when a landscape image is rotated to be oriented as a portrait image, or when an image is taken originally at a 45 degree orientation and subsequently rotated 45 degrees to appear upright, the zoom controls 38 of the camera 12 may be used to enlarge particular aspects of the digital image so as to fill all of the viewing area 60 of the display screen 52 and to eliminate any unused areas (which may otherwise typically appear as black space). Thus, the user may be able to manipulate the image data to produce images that fill the entire viewing area 60 without regard to the orientation of the camera 12 when the image is taken.

One of the additional advantages of embodiments of the present invention is the display screen 52, which is preferably uniquely configured to be much larger than typical display screens on standard digital cameras. As mentioned above, the display screen 52 defines the viewing area 60. According to an aspect of the present invention, the viewing area 60 of the display screen is preferably configured to be a full-framed viewing area. The term “full-framed” is used herein to indicate that the viewing area 60 occupies substantially all of the rear section 22 of the camera 12 for providing maximum size of the display screen 52. Thus, as illustrated in FIG. 2, the viewing area 60 of the display screen 52 should preferably occupy the entire rear section 22 of the camera 12, with only a small border surrounding the viewing area 60. Thus, unlike many conventional cameras, the viewing area 60 will occupy substantially all of the rear section 22 of the camera 12.

In a related embodiment, it is also contemplated that the viewing area 60 may occupy substantially all of the rear section 22 of the camera 12 such that no buttons or features of the camera 12 are present on the rear section 22 of the camera 12. This configuration thus tends to eliminate any buttons or viewfinder apertures from the rear of the camera 12 in order to maximize the size of the display screen 52. Such a configuration is considered to be counterintuitive considering that other cameras have several control buttons, a viewfinder aperture, grips, and other functional or design elements on the rear section of the camera. By eliminating such features from the rear section 22 of the camera 12, embodiments of the present invention allow the size of the display screen 52 to be maximized relative to the size of the rear section 22. As discussed herein, this feature allows for maximum viewing area 60 for using the camera 12 in conjunction with the frame 14. Thus, the overall size of the camera 12 may be no greater than necessary to accommodate a correspondingly large display screen 52.

The display screen 52 may be configured in various dimensions and define any of a variety of aspect ratios, and therefore be rectangular or square in shape. In this regard, the display screen 52 may provide at least 3.5″ diagonal viewing area 60. The display screen 52 may also provide an approximately 5″ diagonal display area, or may even provide an approximately 5″×7″ or 10″×12″ display area. Additionally, a decorative mat border may be added to the frame 14, as is common in a standard picture frame. For example, a decorative mat border may be added to a 10″×12″ display area to adjust the visible space to 5″×7″ or smaller. Such a configuration is common in many displays of photos, paintings, etc.; the displayed picture may be small, but by using several mats and a large ornate frame, the picture is presented in grand fashion. Thus, modifications may be made to the frame, including the use of decorative mat borders to enhance the overall presentation of the image on the camera 12 without increasing the size of the display screen 52 of the camera 12. With a large viewing area 60, the display screen 52 is able to imitate the size of standard photographs that may typically be displayed in desktop frames. It is also contemplated that the display screen 52 may exceed 5″ in order to provide a larger viewing area 60 for the integrated camera/photo display unit 10.

In addition, in order to facilitate use of the camera 12 and the integrated camera/photo display unit 10, the display screen 52 of the camera 12 may preferably be a touch screen. The touch screen may be sensitive to either a stylet or to the simple touch of a human finger. Technology such as is known in the art may be used. In some cases, implementation of this aspect of the present invention may require an appropriate touch sensor, a controller card, and a software driver. When utilized, this feature may significantly enhance the user-friendliness of the integrated camera/photo display unit 10 and facilitate management and use of the integrated camera/photo display unit 10.

According to an aspect of the present invention, the touch screen may be operative to allow the user to control the camera 12. Thus, the touch screen may produce a control signal that is communicated from the communications connector 72 of the frame 14 to the communications port 56 of the camera 12. Alternatively, as also mentioned herein, wireless technology may be utilized. The control signal may allow the user to send commands such as to proceed forward or backwards through a set of images, or to turn the camera 12 and/or frame 14 on or off. Various other functions and commands may be implemented by one of skill in the art.

With regard to the touch screen, as depicted in FIG. 3, the camera 12 may further include image managing software that enables the user to open a menu, visible on the display screen 52, and to select from a variety of options as to how to manage or display the digital images. For example, as shown in FIGS. 3 and 5, the touch screen may provide the user with various options. Each option may represent a thumbnail image of a photo, which may be enlarged or selected when touched. Options 2, 4, 6, and 8 may be used as directional arrows to allow the user to move around in a photo; other options (such as 3 and 9) may be used to zoom in or out of a photo, etc. Many convenient features and functions may thus be served with the touch screen. In particular, the user may select such options with the expectation that the images selected, or the programming thereof, will allow the digital images to be displayed much as a standard photo and frame, as discussed above. Thus, the user may select from a variety of options, such as selecting whether to display a plurality of digital images in a slide show, the time over which a given digital image will be displayed in the slide show or whether to display only one digital image for an indefinite period of time. Further, it is contemplated that a plurality of digital images may be displayed on a subdivided screen; for example, the display screen 52 may be divided into four areas and four separate digital images may be displayed thereon.

Referring now to FIGS. 3-6, the camera-engaging frame 14 includes a cradle 64, a casing 66, and a base 68. The cradle 64 may include an electrical connector 70 and a communications connector 72 being disposed within an interior 74 of the cradle 64. The frame 14 may be manufactured from a variety of materials, such as plastics, woods, metals, and other suitable materials. In addition, the cradle 64, casing 66, and the base 68 may be unitarily formed of a single continuous piece of material or individually formed and attached using an appropriate attachment mechanism, such as adhesives, fasteners, or heat. In this regard, it is contemplated that various other features of the frame 14, such as the electrical connector 70 and the communications connector 72 of the cradle 64 may be attached to the cradle 64 after assembly or fabrication of the cradle 64, casing 66, and base 68. Additionally, other functional or decorative features may also be added to supplement the features noted above.

As shown in FIG. 7, the frame 14 is preferably electrically connectable to a power source 76 and to a computer 78; which may in turn (but are not required to be) be available for use by the camera 12 utilizing the respective ones of the electrical connector 70 and the communications connector 72. Such a configuration may provide for the powering and/or recharging of the camera 12, as well as for the sharing of image data between the camera 12 and the computer 78. Thus, while connected to the electrical connector 70, the camera 12 may provide indefinite playback of digital images and never run out of power. However, while the electrical connector 70 is a preferable element of the frame 14, the electrical connector 70 is not required. For example, in some embodiments, the camera 12 may simply run off of an independent power source, such as batteries.

The communications connector 72 of the frame 14, illustrated in FIGS. 4 and 7, may be operative to transfer the image data to and from the camera 12, and the memory unit 50 may be operative to receive and store the image data transferred from the communications connector 72 of the frame 14 to the communications port 56 of the camera 12. Further, additional digital images may be uploaded to the camera 12 via the communications connector 72 from the computer 78 for playback in the integrated camera/photo display unit 10. Additionally, digital images may be directly sent from the computer 78 to the display screen 52 (be it from the computer 78 or from the internet). For example, remote users may display desired digital images on the display screen 52 by accessing a given display control program that is operatively in communication with the camera 12 via the communications connector 72. Thus, image data may be retrieved or stored on the storage medium 16 of the camera 12 and displayed as desired by the user.

According to another aspect of the present invention, it is contemplated that the electrical connector 70 and the communications connector 72 of the frame 14, as well as the electrical port 54 and the communications port 56 of the camera 12 may be operative to provide wireless communication of data. For example, as discussed herein, the camera 12 and the frame 14 may wirelessly communicate. Thus, the communications port 56 and the communications connector 72 may be wireless communication components, such as receivers, transmitters, and/or transceivers, as are known in the art. In this regard, the communications port 56 and the communications connector 72 may be integrated into the respective ones of the camera 12 and the frame 14 in many locations and configurations, as may be required by user needs or as known by one of skill in the art.

According to another aspect of the present invention, as also mentioned, the camera 12 may not require power through the frame 14, which would eliminate the need for the respective ones of the electrical port 54 and the electrical communicator 70. Instead, each of the camera 12 and the frame 14 may operate off of independent power sources.

As shown in FIGS. 3, 4, and 6, the cradle 64 is sized and configured with at least the bottom end 26 of the camera 12 being removably receivable to within the interior 74 of the cradle 64. As shown therein, the cradle 64 may provide support to the left and right sides 28, 30 and the front section 20 of the camera 12. The cradle 64 need not entirely encompass the camera 12, but should provide sufficient support thereto. When the digital camera 12 is received within the cradle 64, the electrical connector 70 and the communications connector 72 may engage the respective ones of the electrical port 54 and the communications port 56 (depending on the configuration of the camera 12, the electrical port 54 and the communications port 56 may be unnecessary). The electrical connector 70 may be operative to supply power to the electrical port 54 for use by the camera 12, and the communications connector 72 may be operative to perform at least one of transferring the image data from the camera 12 to the computer 78 and transferring the image data from the computer 78 to the camera 12.

Furthermore, with particular regard to the mating between the camera 12 and the cradle 64, it is also contemplated that the camera 12 may include at least one frame engaging member 84, and the cradle 64 may include a camera-engaging member 86. The frame engaging member 84 and the camera engaging member 86 are sized and configured to mutually engage each other for stabilizing the camera 12 when the camera 12 is received within the cradle 64 of the frame 14. The frame engaging member 84 is preferably disposed on the camera, and may be configured as a slot, as shown in FIGS. 1-2 and 6. However, it the frame engaging member 84 may also be formed as protruding from the camera 12, such as a lip or other structure. Furthermore, it is contemplated that the frame engaging member 84 may be removably connectable to the camera 12 and may be joined with the camera 12 upon insertion into the cradle 64 of the frame 14 for providing stability and secure engagement between the camera 12 and the cradle 64. Similarly, the camera-engaging member 86 of the frame 14 may be configured as a protrusion, such as a rail as shown in FIGS. 3-4 and 6. However, the camera-engaging member 86 may also be formed as a slot. In this regard, as will be appreciated by one of skill in the art, the frame-engaging member 84 and the camera-engaging member 85 may be variously structurally configured as protrusions, indentions, or combinations thereof in order to provide stability and secure engagement between the camera 12 and the cradle 64.

Therefore, in utilizing the frame engaging member 84, the camera 12 may thus become a frame engaging full-framed-display digital camera 12, as illustrated in FIGS. 1-2.

According to an implementation of the present invention, the electrical port 54 and the communications port 56 of the camera 12 may engage with the electrical connector 70 and the communications connector 72 of the cradle 64 when the bottom end 26 of the camera 12 is received in the cradle 64 interior 74. However, it is also contemplated that the camera 12 may be variously configured to include the electrical port 54 and the communications port 56 at multiple locations on the sides 28, 30 or ends 24, 26 of the camera 12, which may thus allow the camera 12 to be deposited within the interior 74 of the cradle 64 with any of the top or bottom ends 24, 26 or left or right sides 28, 30 being disposed in the interior 74 of the cradle 64. In such an embodiment, it is contemplated that the electrical connector 70 and the communications connector 72 may engage the electrical port 54 and the communications port 56 through a superficial electrical contact as opposed to a female/male plug connection. In accordance with another embodiment, it is also contemplated that the electrical connector 70 and the communications connector 72 may be flexible, such as wires or plugs that are able to be inserted into the electrical port 54 and the communications port 56 of the camera 12. In this regard, both of the electrical port 54 and communications port 56 of the camera 12, as well as both of the electrical connector 70 and the communications connector 72 of the frame 14, may be configured to provide either a superficial electrical contact or at least one of a male or female plug connection.

In accordance with another implementation of the present invention, the casing 66 may be configured to provide various advantages, including aesthetic benefits. The casing 66 is attachable to the cradle 64 by means of slots, fasteners, or other suitable attachment means. In addition, the casing 66 may also be integrally formed with the cradle 64. As shown in FIGS. 3 and 4, the casing 66 defines a viewing aperture 80 and a rear surface 82. Referring now to FIG. 5, the viewing aperture 80 should preferably be sized and configured to substantially mate with the viewing area 60 of the display screen 52 of the camera 12. According to one implementation, the camera 12 should be tightly fitted against the casing 66 and viewing aperture 80 to reduce any visible gaps between the display screen 52 of the camera 12 and the viewing aperture 80. Thus, when the camera 12 is received within the interior 74 of the cradle 64, the rear surface 82 of the casing 66 should preferably mate with the rear section 22 of the camera 12. This feature may tend to reduce the entrance of light from other areas, which would tend to make the integrated camera/photo display unit 10 appear less similar to a standard photo and frame combination. In this regard, a gasket seal may be provided on the rear surface 82 to substantially surround the viewing aperture 80. The gasket seal may thus be used to eliminate the aforementioned gaps and to enhance the aesthetic appearance of the integrated camera/photo display unit 10.

According to another aspect of the present invention, the frame 14 may include a magnifier element that fits to within the viewing aperture 80, as shown in FIGS. 3 and 5. The magnifier element preferably increases the perceived size of a given image shown on the display screen 52 of the camera 12. Thus, the magnifier element may be incorporated in frames 14 that have large viewing apertures 80, such as 8×10 inches or 11×14 inches, in order to allow the image displayed on the display screen 52 to be enlarged to correspond to the size of the viewing aperture 80. The magnifier element may be made of various types of materials, such as glass, plastic, etc., and may be variously sized and configured to correspond to the size of the viewing aperture 80 and the size of the display screen 52 of the camera. The magnifier element may also be interchangeable in the viewing aperture 80 in order to accommodate various magnification powers corresponding to various sizes of display screens 52. The magnification element may be permanently or replaceably mountable to the frame 14 utilizing adhesives or mounting structures as may be created by one of skill in the art.

Further, the cradle 64 or the casing 66 may be adjustable, such as by pivoting or translational movement, to allow the camera 12 to be received within the cradle 64 with greater ease. For example, the casing 66 may pivotally move from an open to a closed position. The open position may be defined by the rear surface 82 of the casing 66 being disposed distal to the cradle 64, and the closed position may be defined by the rear surface 82 of the casing 66 being disposed adjacent the cradle 64, thus substantially abutting the rear portion of the camera 12 when the camera 12 is received within the cradle 64. Thus, the frame 14 may be configured to allow the user to easily place the camera 12 within the cradle 64.

In another implementation of the present invention, it is contemplated that the casing 66 may be interchangeable and allow the user to select the casing 66 having a desired color, texture, size, material, or shape, or other aesthetic features. Thus, the casing 66 may be removably attachable to the frame 14. Such a configuration may allow for versatility in matching a specific decor or design plan when using the integrated camera/photo display unit 10.

In an implementation of the present invention, the viewing aperture 80 preferably substantially mate with the viewing area 60 of the display screen 52. For example, the viewing aperture 80 of the casing 66 may be configured to accommodate a display screen 52 having a 3.5″ diagonal viewing area 60. Alternatively, the viewing aperture 80 of the casing 66 may be configured to accommodate a display screen 52 having a 5″ diagonal viewing area 60. Nevertheless, the viewing aperture 80 may be sized and configured to substantially mate with the viewing area 60 of the display screen 52 of any dimension.

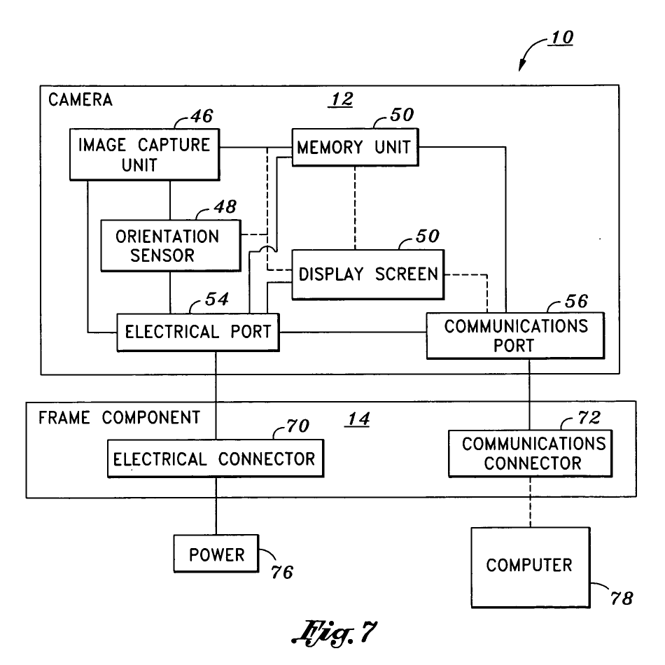

Referring now to FIG. 6, the base 68 of the frame 14 is attachable to at least one of the cradle 64 and the casing 66. The base 68 is sized and configured to support the frame 14 upon a display surface, be it horizontal or vertical. Thus, the base 68 may provide a proper support on a desktop or alternatively, on a wall, as desired. The base 68 may be integrally formed with at least one of the cradle 64 and the casing 66.

In accordance with another aspect of the present invention, it is contemplated that the integrated camera/photo display unit 10 may further include wireless communication capabilities, such as Bluetooth. For example, the camera 12 may be equipped with a wireless unit that is operative to send and receive the image data. Such a feature may allow image data to be sent to a remote printer (as by a picture taker in an amusement park who takes a picture of a family and has the image available at the front office for the family to retrieve) or to at least one remote integrated camera/photo display unit 10 or a simple digital frame (which may be a simple display screen 52 on a wall in a home to facilitate the display of images in multiple locations, the display screen 52 being in communication with a wireless communicator and memory unit 50). Other numerous uses for wireless communication may be combined with the above-described advantages of embodiments of the present invention.

According to another aspect of the present invention, the camera-receiving frame 14 may also include a display screen that is larger than the display screen 52 of the camera 12. Thus, the camera 12 may be received into the frame 14 and communicate the image data to the display screen of the frame 14. The cradle 64 may serve many of the above-mentioned purposes and thereby facilitate the communication between the camera 12 and the display screen of the frame 14. Further, it is contemplated that the frame 14 may receive image data and continue to display the image even when the camera 12 is removed from the cradle 64. Such an embodiment thus allows the camera to have a smaller display screen 52, but nevertheless provides that the image may be displayed on a large, easily visible display screen of the frame 14.

In yet another aspect of the present invention, the frame 14 may optionally include control buttons 88, as shown in FIG. 3. The control buttons 88 may be in electrical communication with the camera 12 when the camera 12 is received into the cradle 64. Thus, a user may utilize the control buttons 88 to control functions of the camera, such as scrolling through pictures, deleting pictures, etc.

Furthermore, it is also contemplated that the integrated camera/photo display unit 10 may include optional speakers for playing audio from the camera 12. Thus, the camera 12 may be operative to record and store audio and may be able to playback the audio, such as when a given image is displayed.

The above description is given by way of example, and not limitation. Given the above disclosure, one skilled in the art could devise variations that are within the scope and spirit of the invention disclosed herein, including various ways of manufacturing, modifying, or combining various features of embodiments of the present invention with other devices. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A full-framed-display camera comprising:
a display screen being disposed on a rear section of the camera and extending about substantially all of the rear section of the camera; and
a data slot being disposed on a side of the camera, the slot being sized and configured to receive a storage medium therein for retrieving and storing the image data.

2. The camera of claim 1 wherein the camera is for use with a camera-receiving frame in displaying a digital image, the frame including a cradle whereinto the camera may be disposed, the camera further including at least one frame engaging member being disposed on the camera, the frame engaging member being sized and configured to engage the frame when the camera is disposed in the cradle.

3. The camera of claim 2 further including an orientation sensor being operative to determine an upright orientation angle of the camera, the orientation sensor producing an orientation signal being representative of the upright orientation angle and being included within the image data, the orientation signal being readable by the camera upon display of the image for orienting the image uprightly on the display screen.

4. The camera of claim 1 wherein the display screen is a touch screen.

5. The camera of claim 1 wherein the data slot is a 6-in-1 data slot.

6. An integrated camera/photo display unit for displaying a digital image, the unit comprising:
a digital camera defining front and rear sections and top and bottom ends, the camera being operative to capture an image, the image being digitally formatted as digital image data, the camera including a display screen, the display screen being disposed on the rear section of the camera and defining a viewing area for displaying the image; and
a camera-receiving frame including a cradle, a casing and a base, the cradle being sized and configured to support the camera, the display screen viewing area being visible through a viewing aperture of the casing when the camera is located in the cradle.

7. The integrated camera/photo display unit of claim 6 wherein the camera further includes an orientation sensor being operative to determine an orientation angle of the camera, the orientation sensor producing an orientation signal being representative of the upright orientation angle and being included within the image data, the orientation signal being readable by the camera upon display of the image for orienting the image upright on the display screen.

8. The integrated camera/photo display unit of claim 6 wherein the frame further includes a communications connector being electrically connectable to a computer and to a communications port of the camera for transferring the image data between the camera and the computer.

9. The integrated camera/photo display unit of claim 8 wherein the communication connector is disposed in the cradle and engageable to the communication port of the camera when the camera is disposed in the cradle.

10. The integrated camera/photo display unit of claim 6 wherein the cradle further includes an electrical connector being configured to engage an electrical port of the camera, the cradle being in electrical communication with a power source to supply power to the electrical connector, the electrical connector being operative to supply power to the electrical port for use by the camera.

11. The integrated camera/photo display unit of claim 10 wherein the electrical connector is disposed in the cradle to engage the electrical port of the camera when the camera is disposed in the cradle.

12. The integrated camera/photo display unit of claim 6 wherein the frame further includes a base being attachable to at least one of the cradle and the casing, the base being sized and configured to support the frame upon a display surface.

13. The integrated camera/photo display unit of claim 6 wherein the rear surface of the casing is disposed adjacent the rear section of the camera upon the camera being disposed in the cradle.

14. The integrated camera/photo display unit of claim 6 wherein the casing is removably attachable to the frame.

15. The integrated camera/photo display unit of claim 6 wherein the display screen of the camera is a touch screen.

16. The integrated camera/photo display unit of claim 6 wherein the display screen of the camera provides at least 3.5″ diagonal viewing area.

17. The integrated camera/photo display unit of claim 16 wherein the display screen is approximately 10″×12″.

18. A camera-receiving frame for displaying an image shown on a display screen of a camera, the frame being electrically connectable to a power source and to a computer, the frame comprising:
a cradle being sized and configured with at least the bottom end of the camera being removably disposable in the cradle; and
a casing being attachable to the cradle and defining a viewing aperture, the display screen of the camera being visible through the viewing aperture when the camera is located in the cradle.

19. The frame of claim 18 wherein the frame further includes a communications connector being electrically connectable to a computer and a communications port of the camera for transferring image data between the camera and the computer.

20. The frame of claim 19 wherein the communication connector is disposed in the cradle and engageable to the communication port of the camera when the camera is disposed in the cradle.

21. The frame of claim 18 wherein the cradle further includes an electrical connector being configured to engage an electrical port of the camera, the cradle being in electrical communication with a power source to supply power to the electrical connector, the electrical connector being operative to supply power to the electrical port for use by the camera.

22. The frame of claim 21 wherein the electrical connector is disposed in the cradle to engage the electrical port of the camera when the camera is disposed in the cradle.

23. The frame of claim 18 wherein the frame further includes a base being attachable to at least one of the cradle and the casing, the base being sized and configured to support the frame upon a display surface.

24. The frame of claim 18 wherein the casing is removably attachable to the frame.
